(19) United States
(12) Patent Application Publication
(10) Pub. No.: US 2006/0231534 A1
(43) Pub. Date: Oct. 19, 2006

(54) Method of laser welding coated members

(76) Inventor: John Edward Hill, Shelby Township, MI (US)

Correspondence Address: CLARK HILL, P.C., 500 WOODWARD AVENUE, SUITE 3500, DETROIT, MI, 48226, US

(21) Appl. No.: 10/567,877

(22) PCT Filed: Aug. 6, 2004
(86) PCT No.: PCT/IB04/02528

§ 371 Date: Feb. 9, 2006

Related U.S. Application Data
(60) Provisional application No. 60/494,610, filed on Aug. 12, 2003.

(51) Int. Cl. B23K 26/26

(52) U.S. Cl. 219/121.64

(57) ABSTRACT

There is disclosed a method of laser welding a number of coated metal sheets including the steps of: providing the coated sheets to be joined, and creating a raised region on at least one of the coated sheets. The raised region is formed on a first surface of the metal sheet while the second opposite surface of the sheet remains continuous and uninterrupted. A laser is then applied forming a weld joint where gases produced during the forming of the laser weld escape via the at least one embossment. In an alternative embodiment fine particles may be distributed on the surface of one or both of the sheets of coated metal to introduce a gap for the gases produced during the forming of the laser weld a place to escape. Preferably the fine particles will be zinc dust to maintain the coating between the two sheets to be joined.

The present invention claims priority from U.S. Provisional Patent Application No. 60/494,610 filed Aug. 12, 2003, the entire content of which is incorporated herein in is entirety.

### FIELD OF THE INVENTION

The present invention relates to a method of laser welding sheet metal, and more particularly, to a method of laser welding sheet metal having a layer of a coating material.

### DESCRIPTION OF RELATED ART

The automotive industry uses a variety of coated or galvanized products to increase the durability of vehicle structures. Weld joints are generally made by spot welding to join together the parts. Through the use of a high powered laser for welding, joints can be made more quickly and with better quality than other alternative joining techniques. In addition, the advantage of having a single side access, as opposed to requiring access to both sides of a work piece for conventional joining techniques, as well as no direct contact with the work piece make laser welding a desirable welding technique.

According to general laser welding practice, two sheets that are to be joined are held together contacting each other along the area to be joined. A laser beam is then energized and swept across the area to be joined welding the sheets together by smelting or melting the metal in the area swept by the laser beam.

A common problem associated with welding coated or galvanized sheet metal includes the vaporization of the zinc galvanized coating resulting in zinc gas explosion leading to a poor weld having defects or pits weakening the joints and creating a visually unacceptable part.

Removal of the protective coating in the weld joint area is an unacceptable alternative to avoid the zinc gas problem discussed above. By removing the galvanized coating, the weld joint would be susceptible to corrosion by external elements, such as the weather, resulting in a shortened life span of a part. Therefore, there is a need in the art for a method of joining galvanized or coated metals using a laser welding technique that results in robust welds without surface defects. There is also a need for a method of laser welding coated metal sheets that is economic and easy to perform without removing a substantial portion of the protective coating resulting in a less corrosion resistant part.

### SUMMARY OF THE INVENTION

There is disclosed a method of laser welding a number of coated metal sheets including the steps of: providing the coated sheets having opposing first and second surfaces, creating a raised region on at least one of the coated sheets, the raised region formed on the first surface and wherein the second surface remains continuous and uninterrupted, and applying a laser beam forming a laser weld wherein gases produced during the forming of the laser weld escape via the raised region. In a preferred aspect the raised region is formed by punching at least one embossment on at least one of the sheets, the embossment includes a depression having a raised peripheral edge.

In an alternative embodiment fine particles may be disbursed on the surface of one or both of the sheets of coated metal to introduce a gap for the gases produced during the forming of the laser weld a place to escape. Preferably the fine particles will be zinc dust to maintain the coating between the two sheets to be joined.

### BRIEF DESCRIPTION OF THE DRAWINGS

FIG. 1 is a diagram illustrating the steps of punching an embossment into the coated metal part forming the embossment of the first embodiment of the invention;

FIG. 2 is a diagram illustrating the joining of two parts by laser welding having the embossments of the first embodiment of the invention;

FIG. 3 illustrates the joining of two coated metal sheets having fine particles disbursed between according to the second embodiment of the present invention.

### DETAILED DESCRIPTION OF THE PREFERRED EMBODIMENTS

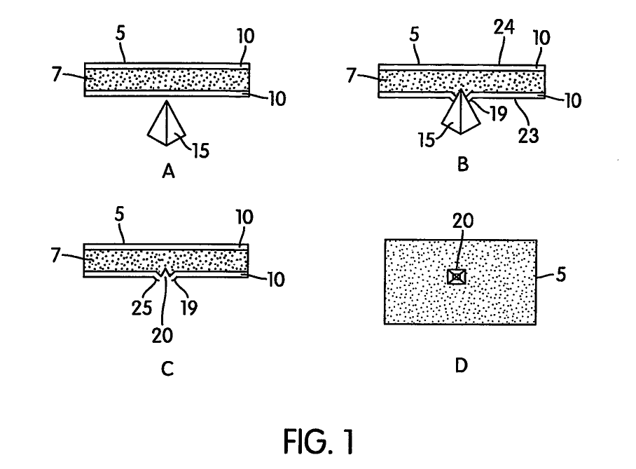

Referring to FIG. 1, there is shown an illustration detailing the formation of a raised region 19 comprising an embossment 20 a first embodiment of the method of the present invention. Referring to FIG. 1A, a coated sheet metal 5 is placed in a press (not shown) which may be associated with an assembly line or may be offline as required. A press for use by the present invention does not require the presence of mating male and female dies as is commonly utilized in the art. Rather the press for use by the present invention requires only an anvil like surface opposite the punch 15; thereby, significantly lowering the cost of tooling.

The coated metal sheet 5 comprises a metal core 7 having layers of coating 10 applied to at least one side and preferably both sides of the sheet 5. A four sided spear-shaped punch 15 is introduced above the coated sheet 5 to create an embossment 20 allowing for the venting of weld gases during a welding process. As shown in FIG. 1A, the spear-shaped punch 15 is a four sided body that preferably comprises a coated metal allowing for repeated use and strength. The spear-shaped punch 15 may be introduced in the upper or lower part of a tool to create the embossment 20 of the present invention.

Referring to FIG. 1B, the spear-shaped punch 15 lances the metal sheet 5 from a direction corresponding to a first surface 23, causing the material on a periphery 25 to rise to a given height. Preferably, the spear-shaped punch 15 does not penetrate the entire metal sheet 5 but only penetrates to a depth sufficient to cause a specific rise at the periphery 25 or edge of the embossment 20. The second surface 24 of the metal sheet 5, opposite the first surface 23, remains continuous and uninterrupted. The second surface may have a contour that is associated with the part, but does not include a raised region or depression from interaction with the punch 15. In a preferred aspect of the present invention, a raised edge of approximately 0.007 inches is formed by the spear-shaped punch 15.

Referring to FIG. 1C, it can be seen that metal is left on the periphery 25 with a slight rise of material allowing for the zinc gas to slow at the interface: As there are no channels which the zinc gas has to follow, the problem of zinc gas solidification further away from the heat resulting in the loss of corrosion protection is avoided. The raised material at the periphery 25 creates a maximum amount of venting of zinc gas during the joining process resulting in an economic joining process easily maintained and controlled.

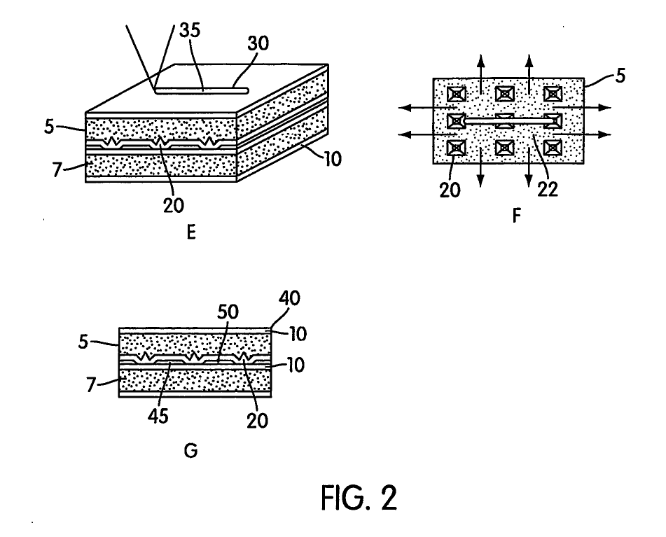

Referring to FIG. 2, the process of the first embodiment utilizing punched embossments 20 to vent weld gases is shown. Referring to FIG. 2E, two metal sheets or parts 5 to be joined are shown, with one of them having the punched embossments 20 previously described with reference to FIG. 1. Although only one part 5 is shown with the punched embossments 20, both parts 5 may include embossments 20 formed as described previously with reference to FIG. 1. As can be seen in FIG. 2E, a laser weld 30 is formed by energizing a beam and drawing it across the part at a weld joint 35. The laser heats the two metal sheets 5 smelting the parts 5 together along the weld joint 35 joining the two parts 5 together. The laser may be continuously drawn over the two metal sheets forming a continuous weld bead or may be energized intermittently to form welds in a specific location.

With reference to FIG. 2F, there is shown a top view of a part having an array 22 of embossments 20 formed by punching as previously described with reference to FIG. 1. The arrows indicate the flow of zinc gas formed by the introduction of the laser shown in FIG. 2E. The array 22 or waffle area of embossments 20 allows the maximum flow of zinc gas formed by the laser to exit and flow without pressurizing and ejecting through the laser keyhole area of the weld joint 35.

With reference to FIG. 2G, the joined part 40 is shown after the introduction of the laser, showing the zinc deposit 45 which forms in the weld area. The zinc gas vaporized by the joining process self-seals the gaps 50 between the two parts 5. As a result, the introduction of the laser should be limited to the minimum size area to be welded, due to the self-sealing effect of the solidification of the zinc gas.

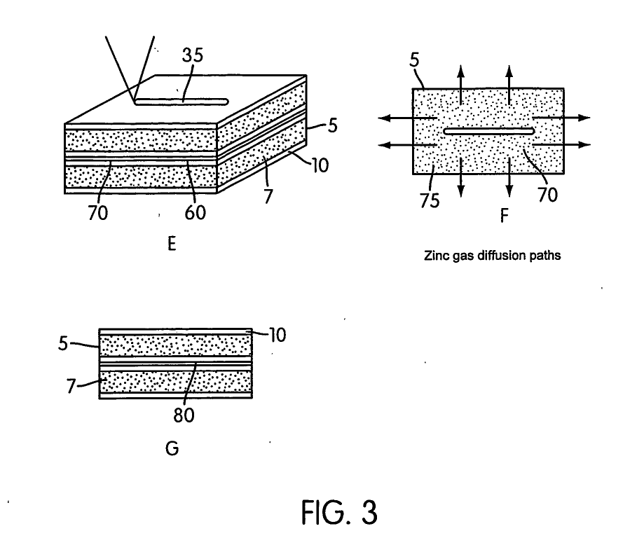

Referring to FIG. 3, there is shown a third embodiment of the method of the present invention. As opposed to forming embossments 20, as described in the first embodiment, fine particles 70 are distributed on the surface 75 of at least one of the sheet metal parts 5 to be joined; thereby, introducing a gap 60 between the two parts 5. The fine particles 70 may be loosely blown on the surface 75 or can be plasma sprayed onto the surface 75 of the coated sheet metal part 5. When using the plasma spraying technique, the particles 70 will be permanently bonded to the surface 75 before the two sheets 5 are joined. The introduction of fine particles 70 between the two sheets 5 will result in a gap 60 between the two sheets roughly the diameter of the particles. In a preferred aspect of the present invention, zinc dust is preferably placed between the two parts 5 to maintain the coating and also create the gap 60 previously described with reference to the diameter of the particles 70. Alternatively, steel dust may be utilized creating a more permanent gap 60 due to the higher melting point of steel, as compared to zinc.

As previously described with reference to the first embodiment, a laser weld is formed by energizing a laser to locally smelt the metal of the two parts 5 to be joined resulting in a laser weld joint 35. The zinc gas formed in the area by the laser is allowed to flow between the particles 70 introduced between the two sheet metal parts 5 thereby preventing the pressurization of zinc gas resulting in ejection through the laser keyhole area. Referring to FIG. 4G, it can be seen that when zinc dust is utilized as the fine particle material 70, the zinc vaporizes and forms a deposit 80 in the weld area similar to the first embodiment. As a result, and as previously described with reference to the first embodiment, it is desirable to minimize the size of the affected area due to the self-sealing effect of the solidification of the zinc gas.

What is claimed is:

1. A method of laser welding a plurality of coated metal sheets comprising the steps of:
providing coated sheets of metal having opposing first and second surfaces;
creating a raised region on at least one of the coated sheets, the raised region formed on the first surface and wherein the second surface remains continuous and uninterrupted;
applying a laser beam forming a laser weld wherein gases produced during the forming of the laser weld escape via the at least one embossment.

2. The method of laser welding a plurality of coated metal sheets according to claim 1 wherein the step of creating a raised region comprises punching at least one embossment on at least one coated metal sheet, the embossment comprising a depression having a raised peripheral edge.

3. The method of laser welding a plurality of coated metal sheets according to claim 1 wherein the step of creating a raised region comprises applying fine particles between the plurality of coated metal sheets.
